(19) United States
(12) Patent Application Publication
(10) Pub. No.: US 2009/0242484 A1
(43) Pub. Date: Oct. 1, 2009

(54) ENVIRONMENTALLY FRIENDLY HYBRID MICROBIOLOGICAL CONTROL TECHNOLOGIES FOR COOLING TOWERS

(76) Inventors: Ana-Mariana Urmenyi, Utrecht (NL); Jeroen A. Koppes, Leiden (NL); Robert L. Wetergrove, Winfield, IL (US); Menno J.T. van Haasterecht, Zoeterwoude (NL)

Correspondence Address: NALCO COMPANY, 1601 W. DIEHL ROAD, NAPERVILLE, IL, 60563-1198, US

(21) Appl. No.: 12/060,296

(22) Filed: Apr. 1, 2008

(51) Int. Cl. C02F 1/44; C02F 1/70; C02F 1/72; C02F 1/76; C02F 1/78

(52) U.S. Cl. 210/650; 210/764; 210/677; 210/675; 210/758; 210/756; 210/754; 210/755; 210/757

(57) ABSTRACT

This is a method that is an environmentally friendly hybrid microbiological control compromising a physical method through fine filtration, which removes nutrients, bacteria and suspended solids from open recirculating cooling systems. The method for microbiological control in cooling systems wherein a recirculating fluid containing an oxidising or a non-oxidising biocide or a mixture of an oxidising and a non-oxidising biocide and is passed through a fine filtration system resulting in reduced microbiological matter, suspended solids and nutrients.

### COPYRIGHT NOTICE

A portion of the disclosure of this patent document contains or may contain copyright protected material. The copyright owner has no objection to the photocopy reproduction by anyone of the patent document or the patent disclosure in exactly the form it appears in the Patent and Trademark Office patent file or records, but otherwise reserves all copyright rights whatsoever.

### TECHNICAL FIELD

This invention relates to environmentally friendly hybrid microbiological control compromising a physical method through fine filtration which removes nutrients, bacteria and suspended solids from re-circulating cooling systems and hence is reducing significantly the biocide consumption and chemical microbiological treatment programs previously required to obtain similar levels of effectiveness.

### BACKGROUND

Particle separation can be performed based on size exclusion. Large size particles are easily removed by sand filtration. However, only filters with small pore size, such as membranes or certain granular media, can separate colloidal particles, bacteria, macromolecules, small molecules, or even ions. Membrane is a physical barrier (thin layer) capable of separating materials as a function of their physical and chemical properties in the presence of an applied driving force. Granular media are formed from small particles and have a small effective pore size.

### DEFINITIONS

Biocides: are active substances, and preparations containing one or more active substances, put up in the form in which they are supplied to the user, intended to destroy, deter, render harmless, prevent the action of, or otherwise exert a controlling effect on any harmful organism by physical, chemical or biological means.
Oxidising Biocides Oxidising biocides are generally non-selective, they can oxidise all organic material including micro-organisms. They oxidise the cell components of organisms, the thinner the cell wall the more vulnerable in organisms is towards oxidising biocides. Because oxidising biocides are non-selective, resistance does not develop. Examples of oxidizing biocides include halogens, active oxygen sources.
Non-Oxidising Biocides: Unlike oxidising biocides, non-oxidising biocides are selective in their mechanism of attacking micro-organisms. They interfere with the metabolism of the organism, disrupt the cell wall, or prevent multiplication. To be effective, typically higher concentrations are required than for oxidising biocides. Micro-organisms can develop resistance/tolerance when the biocide is longer in use, therefore it is good practice to alternate non-oxidising biocides.
Biodispersants and biodetergents Are surface-active chemical, that exibit generally no biocidal characteristics on their own, prevent micro-organisms from attaching to surfaces and accelerate detachment of a biofilm by loosening the slime matrix
Fine Filter is a physical barrier capable of separating materials by their physical and chemical properties. A fine filter is capable of separating particles from fluids in part or all of the range of a few mm to 0.1 nm particle size.
   Membrane is a physical barrier capable of separating materials as a function of their physical and chemical properties when a driving force is applied across the membrane.
   Granular media comprise particles arranged in a container so as to from a physical barrier capable of separating materials by their physical and chemical properties when the materials are forced to move through the granular barrier. The granular medium may be one size or a mixture of sizes. The granules may be silica, anthracite, activated carbon, or other inorganic or organic material.

Depending on the pore size one can distinguish the following membrane techniques: microfiltration (MF), ultrafiltration (UF), nanofiltration (NF) and reverse osmosis (RO).

Ultrafiltration (pore size 0.01-0.1 μm) is used to retain particles of a size of a few nanometres whereas microfiltration, which employs porous membranes with pore diameters between 0.05-10 μm is able to separate particles in the μm size range.

Ultra- and Micro-filtration are pressure-driven barriers to suspended solids and bacteria to produce water with high purity. Suspended solids and solutes of high molecular weight are retained, while water and low molecular weight solutes pass through the membrane. The water and other dissolved components that pass through the membrane are known as the permeate. The components that do not pass through are known as the concentrate. Depending on the Molecular Weight Cut Off (MWCO) of the membrane used, macromolecules may be purified, separated, or concentrated in either fraction.

Because only high-molecular weight species are removed, the pressure differential across the membrane surface is relatively low. Low applied pressures are therefore sufficient to achieve high flux rates from an UF/MF membrane. Flux of a membrane is defined as the amount of permeates produced per unit area of membrane surface per unit time. Generally flux is expressed as liter per square meter per hour (LMH). UF and MF membranes can have extremely high fluxes but in most practical applications the flux varies between 10 and 100 LMH at an operating pressure of about 0.1 bar to 4 bar

UF/MF membrane modules come in plate-and-frame, spiral-wound, and tubular configurations. The configuration selected depends on the type and concentration of colloidal material. For more concentrated solutions, more open configurations like plate-and-frame and tubular are used. In all configurations the optimum system design must take into consideration the flow velocity, pressure drop, power consumption, membrane fouling and module cost.

A variety of materials have been used for commercial polymeric UF/MF membranes like polysulfone (PS), polyacrylonitrile (PAN), polyerthersulfone (PES), cellulose acetate (CA) and polyvinylidene fluoride (PVDF). Also inorganic membranes are used like ceramic membranes.

Ultrafiltration is the membrane separation method with the broadest application spectrum. It is increasingly used in drinking water treatment, removing major pathogens and contaminants such as Giardia lamblia, Cryptosporium oocyts and large bacteria. However, soluble components such as salts and low molecular organic substances usually cannot be retained with ultrafiltration membranes.

There are several factors that can affect the performance of an UF/MF system.
1. Flow Across the Membrane Surface. The permeate rate increases with the flow velocity of the liquid across the membrane surface. Flow velocity if especially critical for liquids containing suspensions. Higher flow also means higher energy consumption and larger pumps. Increasing the flow velocity also reduces the fouling of the membrane surface. Generally, an optimum flow velocity is arrived at by a compromise between the pump horsepower and increase in permeate rate.
2. Operating Pressure. Permeate rate is directly proportional to the applied pressure across the membrane surface. Most membrane modules have an operating pressures limit due to the physical strength limitation imposed to the membrane module.
3. Operating Temperature. Permeate rates increase with increasing temperature due to reduced liquid viscosity. It is important to know the effect of temperature on membrane flux in order to distinguish between a drop in permeate due to a drop in temperature and the effect of other parameters.
Micro and ultrafiltration process takes place at low differential pressure making it a low energy consuming process and MF/UF is removing nutrients and bacteria from the water; the cooling system biofouling potential is retarded hence reducing biocide consumption

### SUMMARY

The current invention describes the following key aspects:
1. It is an advantage of the invention to provide low differential pressure.
2. It is an advantage of the invention to provide removal of fine silt, turbidity, particulate TOC, nutrients reducing biological growth.
3. It is an advantage of the invention to provide high bacteria removal efficiency.
4. Provides a method for regeneration by back flushed or air scrubbed to remove the fouling layer.

### DETAILED DESCRIPTION

The current invention describes a method for microbiological control in cooling systems where in a recirculating fluid containing a biocide and is passed through a fine filtration system wherein the recirculating fluid may be diverted to a side stream then passed through the fine filtration system.

The inventions fine filtration system contains membranes that have a pore size at 5 or less μm preferable having a pore size from 0.01 to 0.5 μm. The inventions fine filtration system may also contain membranes that are micro ultra-filtration membranes. These membranes can be regenerated by back flushed the system or by air scrubbing the system.

The claimed invention uses an oxidising biocide that is preferably one or more of the following: chlorine, hypochlorite, ClO2, bromine, ozone, hydrogen peroxide, peracetic acid and peroxysulphate. Additionally the invention may use a non-oxidising biocide that is preferably one or more of the following: glutaraldehyde, dibromo-nitrilopropionamide, isothiazolone, quaternary ammonium, terbutylazine, polymeric biguanide, methylene bisthiocyanate and tetrakis hydroxymethyl phosphonium sulphate. The claimed invention may also use a mixture of an oxidising biocide and a non-oxidising biocide with the preferred examples listed above.

### EXAMPLES

The foregoing may be better understood by reference to the following examples, which are intended to illustrate methods for carrying out the invention and are not intended to limit the scope of the invention.

It should be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

Microbiological control, biocide usage, were followed in a pilot cooling tower (PCT) in the presence and absence of a physical method membrane filtration (ultrafiltration) that, due to size exclusion, is removing particulate matter including bacteria, with a size larger then 0.010□m.

### Ultrafiltration Device:

An ultrafiltration device was rented from Norit BV. The main characteristics of the unit and membrane are presented in the appendix. The unit is composed from a tank (volume 25 l) where the water is concentrated. A level controller controls the level of the water in the tank. From the tank the water is pumped with the help of pomp PO1 over the membrane. The concentrated is passed through a cooling system and then is returned to the storage tank. The permeate is added to the basin of the cooling tower.

To prevent membrane fouling a minimal flow velocity of 2 m/sec was run over the membranes. Opening or closing of valves V1 and V2 adjusted the flow. Valves V1 and V2 were never closed completely. In addition, according to the supplier specifications, the feed pressure flow in P1 was not exceeding 1 bar (blow up of membranes). The membranes should never become dry after the first use (always keep them wet)

The cross-flow membrane was an 8 mm hollow fibber, inside-out filtration. The pilot unit was initially equipped with 2 membrane modules with a surface are of 0.15 m² each, total membrane surface is 0.3 m².

### UF Membrane Cleaning for Start-Up:

When new membranes were used, first the glycerin that keeps the membrane wet and biocide were rinsed out (to prevent degradable COD to enter the cooling tower as additional food source). The tank 1 (see FIG. 1) was filled with DI water and recirculated over the membranes according suppliers (Norit) recommendations. After 30 minutes the water is drained. The procedure is repeated at least three times. Finally the system is drained, valve nr 301 is closed and tank nr 1 is filled with water from the PCT basin while permeate is re-introduced into the PCT basin.

Pilot Cooling Tower (PCT) Tests with and without Membrane Device:

Cooling water hybrid physical/chemical microbiological treatment performance test was run using the Nalco standard PCT equipment with a setup. The volume of the basin was 200 L. For the base line an extra tank of 25 L was added to the basin, to simulate tank 1 when UF device was used. The tank 1 was heated to 30° C. temperatures similar to tank 1

The PCT test was run using metal tubes. All tubes were put in service after thorough degreasing, without any pre-passivation. Coupons were also included in the test. The PCT test was started without heating for the first 12 hours to allow initial corrosion reactions to come to rest. After this, heat was applied as described in Table 3. The test was started with cycled up water. Cooling water treatment 3DT165 product were dosed based on the Nalco Trasar technology. Blowdown was controlled by 3DTrasar based on conductivity set point when no membrane unit was in use.

When UF unit was running, the blow-down was set manually using a pump and once per day removing the concentrate from the tank 1. The total volume of the blow-down was equivalent to the blow-down controlled by the 3DT unit.

The PCT was inoculated with cultured bacteria (Pseudonromas) to reach microbiological levels of about 10⁵ cfu/mL. The inoculation was done at the beginning of each test. Liquid nutrients (Nutrients broth 4 g/L, supplier Oxio) were added to the system with a speed of 0.01 g/L/day continuously. Microbial control was carried out using hypobromite. The biocide dosage was done based on ORP control.

Make-up water chemistry was checked using ICP. Relevant parameters of the recirculating cooling water were analyzed or verified using field test methods on a daily basis. Following parameters were tested routinely: pH, M-alkalinity, conductivity, calcium and total hardness, ortho phosphate, total phosphate and polymer level.

### PCT-Ultrafiltration

To the PCT basin the UF unit was mounted. Water from the basin was added continuously to the tank 1 of the UF unit. The level of the water in the tank was maintained constant using a level controller. The pomp P02 was removing continuously a volume of 1.4 l/h as blow-down and disposing 101/day concentrate from tank 1. The permeate is re-introduced into the basin. The permeate flow was kept at 20-25 l/h. When the permeate flow dropped about 15% from the initial values. A cleaning procedure was performed.

### UT Unit Cleaning Procedure:

UF unit was cleaned during the case study 1 everyday. The same procedure is followed also for the case study 2 with the difference that cleaning procedure was applied only when the permeate flow dropped below 15% from the initial permeate flow. First, the feed water is closed while the permeate is inserted to the cooling tower basin. When the concentrated has a volume of about 10 L, the permeate tube is removed from the basin and it is introduced to the tank. The concentrate is removed and disposed to the drain. The tank was filled with DI water, biodetergent and biocide (hyphochlorite) and recirculated in agreement with suppliers (Norit) recommendations. The permeate water and recirculated water are kept in the tank. After 30 minutes, the pomp is stopped and the water is drained. Clean DI is added to the system and is recirculated over the UF membrane. The procedure is repeated at least three times. Finally the system is drained, valve nr 301 is closed and the tank nr. 1 is filled with water from the basin while permeate is re-introduced into the PCT basin.

### Example 1

### ORP 260 mV

| | Biocide Use g/h | | TVC [cfu/ml] | |
|---|---|---|---|---|
| Days | without UF] | with UF- | without UF] | with UF- |
| 11 | 0.951 | 1.04 | | |
| 12 | 1.111 | 0.97 | 3.70E+05 | 1.03E+04 |
| 13 | | 0.82 | 4.20E+05 | 1.38E+04 |
| 14 | | 1.15 | 5.00E+05 | 6.00E+03 |
| 15 | 0.642 | 0.95 | | 6.40E+02 |
| 16 | 0.745 | | | |
| 17 | 0.875 | 0.83 | 1.80E+05 | 1.33E+03 |
| 18 | | 0.61 | 2.60E+05 | 4.30E+03 |
| 19 | 0.728 | 0.86 | 3.00E+05 | 3.40E+03 |
| Average | 0.84 | 0.90 | 3.38E+05 | 5.68E+03 |

### Example 2

### ORP 200 mV

| | Biocide Use g/h | | TVC [cfu/ml] | |
|---|---|---|---|---|
| Days | without UF] | with UF- | without UF] | with UF- |
| 11 | 0.433 | | 3.60E+04 | |
| 12 | 0.592 | 0.326 | 3.80E+04 | |
| 13 | | 0.241 | 1.71E+05 | 7.80E+04 |
| 14 | | | 2.30E+05 | 8.50E+04 |
| 15 | 0.633 | | 1.42E+05 | 6.80E+04 |
| 16 | | 0.311 | | 1.49E+05 |
| 17 | | | | 1.46E+05 |
| 18 | 0.556 | 0.339 | 5.10E+04 | |
| 19 | 0.600 | 0.208 | 5.50E+04 | |
| Average | 0.5628 | 0.285 | 1.03E+05 | 1.05E+05 |

We claim:

1. A method for microbiological control in cooling systems where in a recirculating fluid containing a biocide and is passed through a fine filtration system.

2. The method of claim 1 wherein the recirculating fluid is diverted to a side stream then passed through the fine filtration system.

3. The method of claim 1 wherein the fine filtration system contain membranes that have a pore size at 5 or less μm.

4. The method of claim 1 wherein the fine filtration system contain membranes that have a pore size from 0.01 to 0.10 μm.

5. The method of claim 1 wherein the fine filtration system contain membranes that are micro ultra-filtration membranes.

6. The method of claim 1 wherein the fine filtration system is back flushed to regenerate the membranes.

7. The method of claim 1 wherein the fine filtration system is air scrubbed to regenerate the membranes.

8. The method of claim 1 wherein the biocide is an oxidising biocide.

9. The method of claim 6 wherein the oxidising biocide is one or more of the following: chlorine, hypochlorite, ClO2, bromine, ozone, hydrogen peroxide, peracetic acid and peroxysulphate.

10. The method of claim 1 wherein the biocide is a non-oxidising biocide.

11. The method of claim 10 wherein the non-oxidising biocide is one or more of the following: glutaraldehyde, dibromo-nitrilopropionamide, isothiazolone, quatemary ammonium, terbutylazine, polymeric biguanide, methylene bisthiocyanate and tetrakis hydroxymethyl phosphonium sulphate.

12. The method of claim 1 wherein the biocide is a mixture of an oxidising biocide and a non-oxidising biocide.

13. The method of claim 1 wherein the biocide is one or more of the following: chlorine, hypochlorite, ClO2, bromine, ozone, hydrogen peroxide, oxygen based biocides, peracetic acid, peroxysulphate, glutaraldehyde, dibromo-nitrilopropionamide, isothiazolone, quaternary ammonium, terbutylazine, polymeric biguanide, methylene bisthiocyanate and tetrakis hydroxymethyl phosphonium sulphate.

14. A method for microbiological control in cooling systems where in a recirculating fluid containing an oxidising or a non-oxidising biocide or a mixture of an oxidising and a non-oxidising biocide and the recirculating fluid is passed through a fine filtration system contain membranes that have a pore size at 5 or less μm.

15. The method of claim 14 wherein the fine filtration system contain membranes that are micro ultra-filtration membranes.

16. The method of claim 14 wherein the fine filtration system is back flushed to regenerate the membranes.

17. The method of claim 14 wherein the fine filtration system is air scrubbed to regenerate the membranes.
